(19) United States
(12) Patent Application Publication
(10) Pub. No.: US 2016/0021909 A1
(43) Pub. Date: Jan. 28, 2016

(54) LOW DENSITY CHEWING GUM AND SYSTEMS AND PROCESSES FOR MAKING SUCH

(71) Applicant: WM. WRIGLEY JR. COMPANY, Chicago, IL (US)

(72) Inventors: Scott G. BROWN, Oswego, IL (US); Dominic LETTIERE, Oak Lawn, IL (US); Joo SONG, Chicago, IL (US)

(21) Appl. No.: 14/773,928

(22) PCT Filed: Mar. 12, 2014
(86) PCT No.: PCT/US14/24732

§ 371 Date: Sep. 9, 2015

Related U.S. Application Data
(60) Provisional application No. 61/791,176, filed on Mar. 15, 2013.

(51) Int. Cl. A23G 4/18; A23G 4/02

(52) U.S. Cl. CPC A23G 4/18; A23G 4/02

(57) ABSTRACT

Systems and methods are provided for making a shaped gum product composed of agglomerated individual strands of gum. The gum product is induced through a plurality of apertures in a forming die to form individual strands of extruded gum product. The individual strands of gum product are then cooled by a cooling system, such as a blower and/or a cooled conveyor and form an agglomerated mass of cooled individual strands of gum product. Agglomerated mass of gum product is then formed into a predetermined shape and configuration, for example by slicing and/or scoring.

### PRIORITY DATA

The present patent application is a 371 of International Application Ser. No. PCT/US14/24732 filed Mar. 12, 2014, which claims benefit from Ser. No. 61/791,176 filed Mar. 15, 2013, now expired. The applications listed above are incorporated by reference from as if entirely restated herein.

### BACKGROUND OF THE INVENTION

The present invention generally relates to a gum product. More particularly, the present invention relates to a formed gum product composed of agglomerated individual strands of gum.

There are many prior art methods for making gum, but arguably the most popular and widely used prior art gum making systems include the formation of a uniform slab of gum product which may then be sliced into individual pieces. The individual pieces are typically uniform in consistency. The slab itself is typically formed by heating and rolling a mass of gum product to achieve a desired height.

Additionally, with products such as Big League Chew®, the gum slab is shredded or cut into many thin strands and then poured into a pouch and sold as loose strands. Additionally, the diameter of the shredded gum is quite thick. Additionally, standard gum undergoing the shredding process is not stretched or formed.

Forming the gum pieces from the slab may be energy and space intensive. For example, energy is typically required to heat the gum product prior to and during rolling, as well as to perform the actual rolling. Additionally, because the slab is typically cooled after rolling, substantial electrical energy is typically required to cool the slab. Typically, it is desired to keep the gum slab more flexible during rolling and then less flexible for packaging.

With regard to space usage, the heating and rolling systems typically require significant space. However, the system for heating and cooling the slab is often many feet long and thus typically requires a significant space footprint—as well as the significant energy usage mentioned above.

The gum product itself is typically composed of a gum base and one or more bulking sweetening agents, such as sugars, polyols, or a combination thereof. Additional ingredients may also be included, such as, but not limited to fiber, flavors, colors, actives, and high intensity sweeteners. With regard to the ingredients in the gum product itself, market research has identified that the consumer typically desires a gum product that includes sweetness and flavor, but that also provides a preferred amount of gum cud or residual that allows the consumer to chew the gum for a long time. In this regard, a gum cud of 0.2 to 0.6 g may typically be desired.

One or more common traditional gum processes include extruding a ribbon or sheet which is then rolled (or sheeted) while warm and flexible, until it is at the desired thickness. The gum is then cooled on line or taken off line to cool. The gum is typically cooled to a firmness sufficient to package. Examples of packaging include wrapping in paper or film.

Therefore, it would be useful to have a gum production process that could deliver a gum product that would have a unique appearance while delivering consumer acceptable flavor and sweetness delivery as well as acceptable gum residue.

### BRIEF SUMMARY OF THE INVENTION

One or more of the embodiments of the present invention provide systems and methods for making a shaped gum product composed of agglomerated individual strands of gum product. The individual strands of gum product are extruded from an extruding die and then cooled using a cooling system such as a blower and/or cooled conveyor belt to form an agglomerated mass of individual strands of gum product. The agglomerated mass of individual strands of gum product may then be shaped, formed, cut, and scored into a predetermined desired shape for the gum product.

### BRIEF DESCRIPTION OF THE DRAWINGS

FIG. 1 illustrates an example of individual cooled strands of gum product.

FIG. 2 illustrates an example of individual cooled strands of gum product of FIG. 1 that has been formed into a formed slab of agglomerated strands of gum product 200.

FIG. 3 illustrates a flowchart 300 of a method or process of producing a shaped gum product.

FIG. 4 illustrates an embodiment of the system for forming a shaped gum product having a blower and cooling belt conveyor.

FIG. 5 illustrates an embodiment of the system with a blower and two angled conveyor belts.

FIG. 6 illustrates an embodiment of the system with a blower and a perforated cooling belt.

FIG. 7 illustrates an embodiment of the system with a plurality of blowers and a perforated cooling belt.

FIG. 8 illustrates one embodiment of the extrusion plate and blower.

### DETAILED DESCRIPTION OF THE INVENTION

It would be useful to have a product and process for making it that supplies an acceptable chewing gum product that has a uniform texture and contains a desired amount of gum cud during chewing. An additional advantage would be a process for making such product that requires less energy and space footprint than traditional chewing gum processes.

As mentioned above, one advantage of one or more embodiments of the present gum product made from agglomerated individual strands is that as the strands are agglomerated, pockets of air typically form in the agglomerated product. Consequently, the products containing the agglomerated strands are typically less dense than prior art gum products that are simply composed of a sliced slab of gum product. In one embodiment, the lessening of density may be embodied as less gum volume per unit volume of the finished gum product. In another embodiment, the lessening of density may be embodied as less weight of gum per unit volume of the finished gum product.

In this regard, as mentioned above, market research has identified that the consumer typically desires a gum product that includes sweetness and flavor, but that also provides a preferred amount of gum cud, or residual, that allows the consumer to chew the gum product for a long time. The lesser density of the agglomerated strands may allow the gum product to be composed of a gum formulation that has been designed to still provide the sweetness and flavor as desired by the consumer while simultaneously providing the desired residual, but doing so using a lesser amount of the bulking sweetener agent.

Additionally, typical prior art gum making machines take a gum mass, roll the mass of gum product into a slab using one or more successive rollers, cool the slab of gum product, and then slice and cut the slab. The machinery for implementing these process steps typically requires a significant amount of space, capital investment, and/or electrical power. For example, the cooling of the slab of gum product may require a conveyor belt that is many feet long and passes through a cooling chamber, or uses cooled conveyor belts. Both the conveyor belt and the cooling chamber are cost and energy intensive means to merely maintain the gum slab at a cool temperature, much less to cool the heated slab.

Conversely, one or more embodiment of the present system may proceed directly from a gum mass through extrusion, blowing, agglomeration, and forming in a matter of a few meters, which represents a significant space and/or footprint savings over prior gum making systems. Additionally, the present system may require a significantly lower capital investment than prior art gum systems because several components are eliminated and/or reduced in size. Also, the present system may require less electrical power to produce the gum product. For example, the power used to maintain a cooling chamber in the prior art system may be eliminated in favor of an air blower.

Additionally, it is noted that prior art systems for manufacturing gum products typically operate by producing slabs of gum product that are uniform in consistency and are then cut into individual chunks or pieces of gum product. The formation of a gum product by agglomeration is viewed as a completely new and unique system and method for forming a gum product.

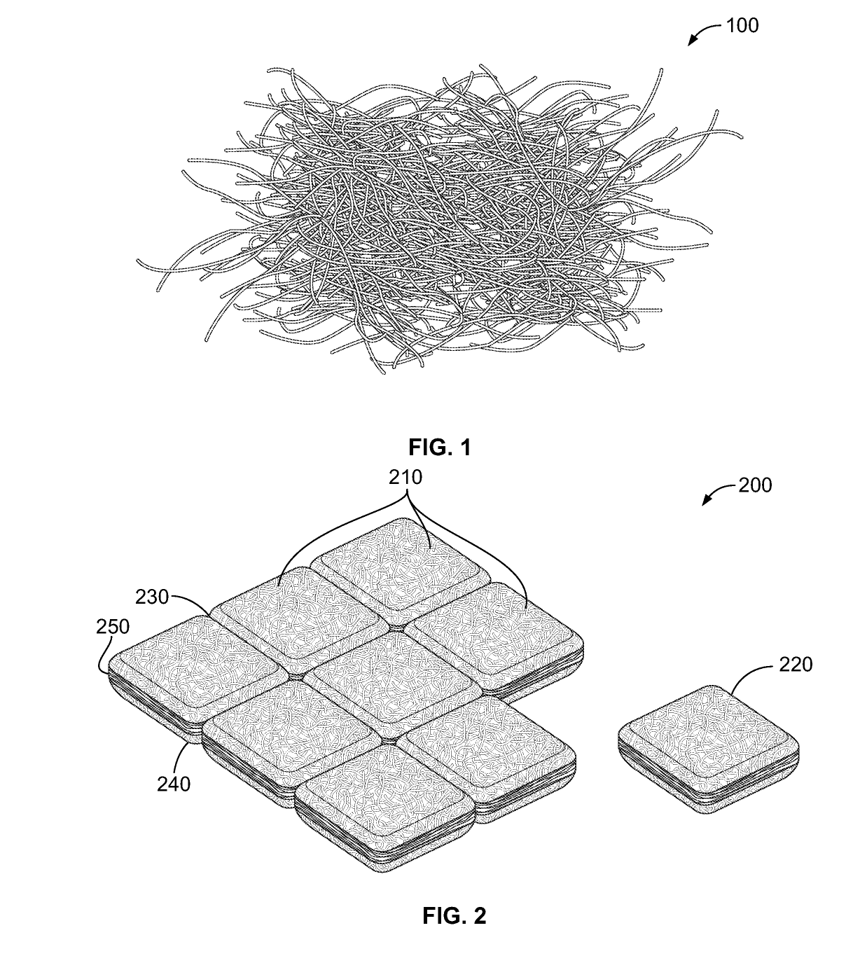

FIG. 1 illustrates an example of individual cooled strands 100 of gum product. As seen in FIG. 1, although the individual strands of the gum product 100 may be in contact and may adhere to each other, in one embodiment the strands do not typically significantly deform and still substantially retain their shape as individual strands.

As further described below, in one or more embodiments, a gum mass of unformed gum is passed through a shape former to form individual strands of gum. The gum mass may also be referred to as a mass of gum product. The individual strands of gum may also be referred to as individual strands of gum product.

The individual strands of gum are then agglomerated to form agglomerated strands of gum. The agglomerated strands of gum may also be referred to as an agglomerated mass of individual strands of gum.

The agglomerated strands of gum may then be formed into a formed slab of agglomerated strands of gum product. The formed slab of agglomerated strands of gum product may then be cut into individual pieces of finished gum product.

One or more embodiments of the gum product recited below may use one or more of the following formulations. The formulas are examples for use with the process and equipment recited herein.

### Embodiment #1

TABLE 1
Chewing Gum Formula 1

| Ingredients | Weight Percentage |
|---|---|
| Gum Base | 71.6 |
| Bulking Agent | 18.4 |
| Flavors and HIS (High Intensity Sweetener) | 5.0 |
| Lubricant | 5.0 |
| Total | 100% |

Embodiment #2

TABLE 2
Chewing Gum Formula 2

| Ingredient | Weight Percentage |
|---|---|
| Gum Base | 67.0 |
| Bulking Agent | 23.0 |
| Flavor and HIS (High Intensity Sweetener) | 5.0 |
| Lubricant | 5.0 |
| Total | 100% |

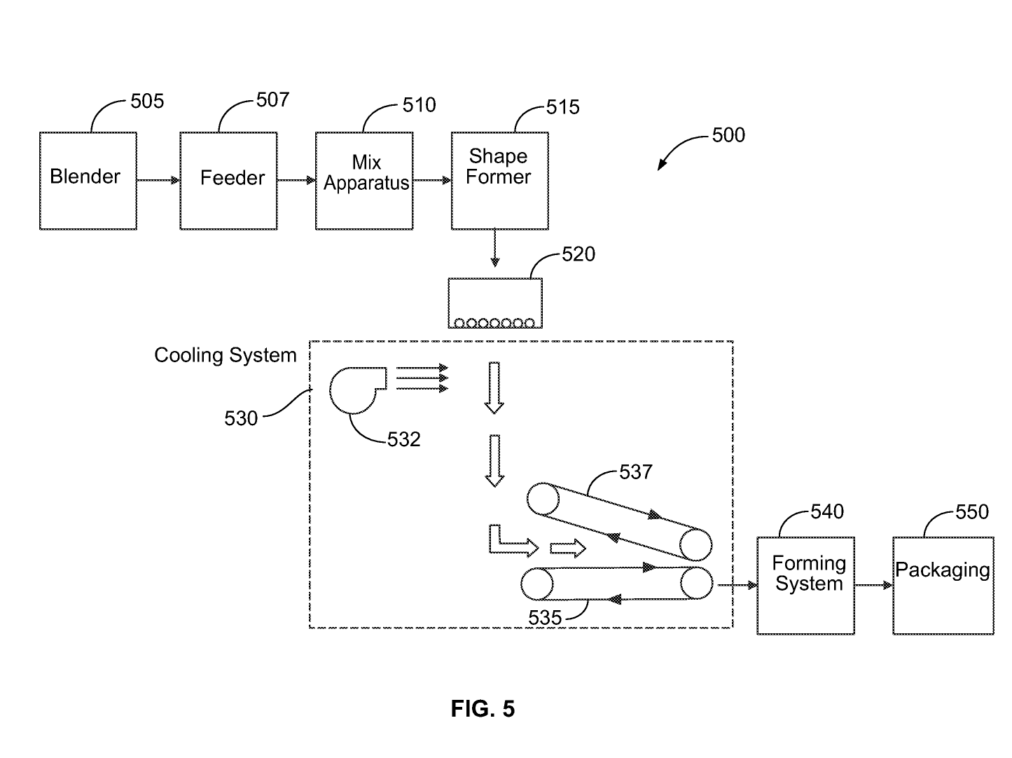

FIG. 2 illustrates an example of individual cooled strands of gum product of FIG. 1 that has been formed into a formed slab of agglomerated strands of gum product 200. As shown in FIG. 2, the formed slab of agglomerated strands of gum product is substantially in the shape of a flat plane, sheet and/or ribbon that may be formed, for example, by the operation of bottom cooling belt conveyor 535 and top cooling belt conveyor 537 of FIG. 5 below. Alternatively, the shape may be described as a rectangular and/or cubic bundle. The temperature conditions are such that the individual strands may partially adhere to neighboring individual strands, but the strands do not combine into one solid mass. As an alternative description, when combined to form the formed slab of agglomerated strands of gum product 200, the individual strands may still be visually observed as individual strands, but the adherence and contact between individual strands has been increased as a result of the forming process. The agglomerated strands of gum product may also be referred to as a nested mass, typically before being formed into a formed slab.

Additionally, the agglomerated mass of individual cooled strands of gum product has been scored to form a grid of nine individual areas 210 of the gum product that may be broken off or separated by a user to form up to nine individual pieces of gum product, such as the individual piece of gum product 220.

The gum product 200 includes a plurality of score lines 230, 240 that run transversely across the gum product and are present along both the top and bottom surfaces of the gum product. As mentioned above, the score lines 230, 240 do not penetrate the entire height of the gum product, but instead leave a center region of the gum product 250 as a connector between adjacent individual areas 210 of the gum product.

Alternatively, the gum product 200 may be presented in virtually any predetermined shape. In addition to the rectangular and/or cubic bundle mentioned above, the gum product may be configured as a circle, ovoid, or other shape such as stylized letters or numbers, for example. Additionally, the individual pieces of gum product may be configured in virtually any predetermined shape such as squares, cubes, rectangles, spheres, circles, ovoids, or as stylized letters or numbers, for example.

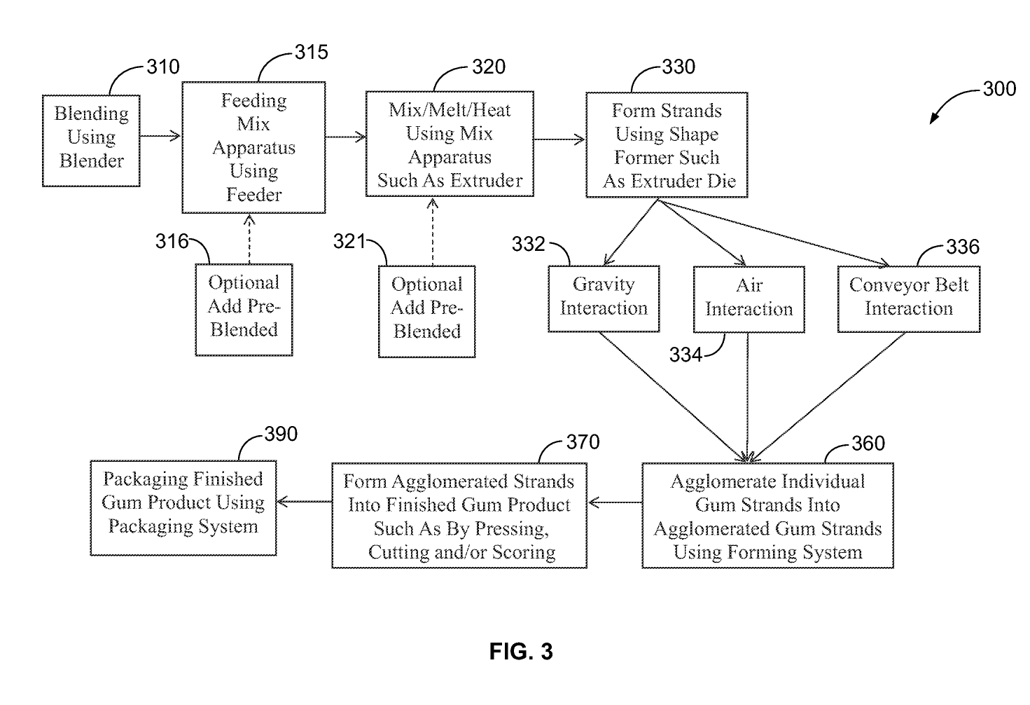

FIG. 3 illustrates a flowchart 300 of a method or process of producing a shaped gum product. First, at step 310, gum is blended using a blender to form a gum mass. The gum mass may include individual components that are then blended or a pre-blended mixture. Next, at step 315, the gum mass may be fed to a mix apparatus using a feeder. Additionally, as an option shown in step 316, additional pre-blended materials may be added to the gum mass at this time.

Next, at step 320, the blended gum mass may be mixed, melted, and/or heated, for example by using a mix apparatus such as an extruder. Additionally, the blended gum mass may be conveyed, for example to a shape former such as an extruder. Additionally, as an option shown in step 321, additional pre-blended materials may be added to the gum mass at this time.

Then, at step 330, the shape former may form the gum mass into individual strands of gum product, for example, by extruding the gum mass through an extrusion die. The process may also use a pump to move the gum mass from the feeder to the extrusion die. As mentioned above, in one embodiment the gum mass that passes through the extrusion die nozzle is extruded as several individual threads of gum product. In one embodiment, one or more of the individual threads of gum product are cylindrical, ovoid, rectilinear, square, or triangular. The flow rate of gum mass through the extrusion die is preferably such that an even stream of gum mass flows out of the extrusion die nozzle openings. The strands/streams of gum elongate and thin as they fall by gravity and by air flow from the fans/blowers as described below.

Thus, once the individual strands of gum pass out of the shape former, the individual strands of gum typically undergo gravity interaction in step 332, air interaction at step 334, and conveyor belt interaction at step 336. These interactions may occur during overlapping periods of time. For example, the individual strands may be falling due to gravity, be impacted by blown air, and then impact a conveyor belt, possibly while still being impacted by blown air.

More specifically, as the individual strands of gum pass out of the shape former, they may be passing through die holes in an extruder die. The individual strands may then experience elongation due to the interaction with gravity. Further, the individual strands may experience elongation due to air flow. More specifically, the air flow may be directed so that it imparts a force on the individual strands that causes the strands to stretch and/or elongate.

All of the gravity interaction 332, air interaction 334, and conveyor belt interaction 335 may contribute to a cooling system for the individual strands. For example, by simply falling under the force of gravity, the strands may be exposed to air at a relatively cooler temperature and thus cool. Further, the blown air that impacts the strands may increase the heat transfer of the strands and consequently accelerate cooling. Further, the blown air may be cooled and/or humidified which may also increase cooling. Finally, the conveyor belt may be cooled so that when the strands come into contact with the conveyor belt the strands are further cooled.

At step 360, the individual strands are then agglomerated into agglomerated gum strands. As discussed herein, for example, the agglomeration may start taking place as the threads are blown by a blower and come into contact with each other. Additionally, the strands may become entangled as part of the agglomeration process. The agglomeration may continue as the threads fall to the conveyor belt and come into contact with threads that have previously fallen to the conveyor belt. Additionally, further agglomeration may take place in embodiments where the threads are mechanically induced into contact with each other, for example, such as the embodiment shown in FIG. 5 with two opposing conveyor belts.

Next, at step 370, the agglomerated individual strands of gum may be formed into a finished gum product, such as by pressing cutting, and/or scoring. For example, the agglomerated strands of gum product may be formed into a formed slab of agglomerated strands of gum product as shown in FIG. 2. The formed slab may then be cut into a size as desired using cutting or slicing, for example. Additionally, the gum product may be scored as desired, for example to partially segment or divide the gum product into portions or pieces that may be easily separable by a consumer.

Finally, at step 390, the sized and scored gum product (and/or individual pieces of gum product) is packaged for sale to the consumer and/or for transportation.

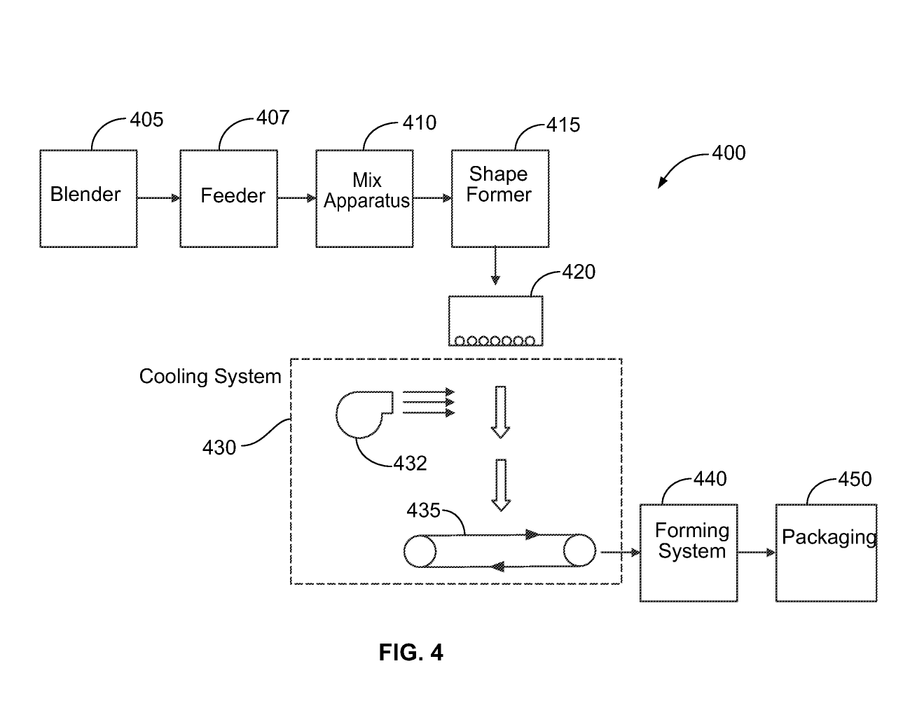

FIG. 4 illustrates an embodiment of the system for forming a shaped gum product having a cooling system including a blower and cooling belt conveyor 400. The embodiment of FIG. 4 includes a blender 405, a feeder 407, a mix apparatus 410, a shape former 415, apertures 420, a cooling system 430 including a blower 432 and a cooling belt conveyor 435, a forming system 440, and a packaging system 450.

In operation, gum mass is placed and/or fed into a mix apparatus such as the blender 405. Alternatively, ingredients may be loaded into the blender 405 and then blended to form the gum product. Alternatively, the gum mass may be introduced into a heater and then into a blender and/or an extruder. Additionally, the gum mass is preferably blended until it is homogeneous. The gum mass is then passed from the blender 405 to the feeder 407. The feeder 407 feeds the gum mass into the mix apparatus 410. The mix apparatus 410 may then mix the gum mass or adjust the temperature of the gum mass, for example by introducing heat or melting the gum mass. The mix apparatus 410 then forces or conveys the gum mass through the shape former 415, such as an extruder having an extrusion die with apertures 420. Alternatively, an extrusion guide plate or another shape former may be used instead of or in addition to an extrusion die.

As mentioned above, the shape former 415 includes several small separate apertures 420. In one embodiment, the shape former 415 may be an extruder and the apertures 420 may be apertures in an extrusion die. The gum mass passes through the apertures 420 and is thereby formed into individual strands of gum product. In one embodiment, the gum mass may be heated before it passes through the apertures. Alternatively, the gum mass may be heated, cooled, and heated in succession before being passed through the apertures.

The individual strands of gum product are then cooled by the cooling system 430. More specifically, the individual strands of gum product are cooled by coming into contact with air that is induced into contact with the individual strands of gum product by the blower 432. The air blown by the blower 432 into the individual strands of gum product may be at room temperature or may otherwise be cooled. In addition, other fluids such as nitrogen or carbon dioxide may be added to the air emitted from the blower 432. In one embodiment, the other fluids may be added to the air emitted to the blower if the individual strands exceed a certain predetermined temperature.

The air emitted from the blower 432 may also be moisture-controlled to have a greater or lesser moisture content than the ambient air. The blower 432 may also cause the individual strands to lessen in diameter somewhat either through cooling, reduction in moisture, or stretching as the individual strands are impacted and spatially displaced by the air from the blower 432. In one embodiment, the stretching may be significant. For example the aperture may include a nozzle having a diameter of 1 mm and the individual strand that is extruded may be as small as 0.2 mm.

In one embodiment the stretching of the individual strands may be desirable to assist in preventing the gum product from forming into drops or clumps. Additionally, although the strands of gum product may be combined in a non-uniform and/or random way due to their movement in response to blown air and/or how they impact on the conveyor, the strands may alternatively form a pattern. For example, the position of the extrusion die relative to the conveyor may be controlled so that the extrusion die may make several side-to-side passes over a temporarily stopped or slowly moving conveyor. Such a process may cause several layers of individual strands of gum product to be deposited on top of each other on the conveyor belt in a somewhat or substantially uniform way to form a pattern.

After the individual strands of gum product pass through the air generated by the blower 432, the individual strands of gum product collect on the cooling belt conveyor 435 and form an agglomerated mass of individual strands of gum product. The cooling belt conveyor 435 may cool the gum product in any of several ways. In one example, the cooling belt conveyor 435 cools the gum product by allowing the gum product to come into contact with the ambient air as the gum product is transported by the cooling belt conveyor 435. In another example, the cooling belt conveyor 435 may have internal elements that cool the belt of the conveyor so that the cooling belt conveyor 435 provides additional cooling to the gum beyond that provided by the ambient air. In another embodiment, the cooling belt conveyor 435 passes through a cooling chamber prior to contacting the gum, for example on the return path of the conveyor belt, and is cooled to provide additional cooling. Additionally, the cooling belt conveyor 435 with the gum may pass through a cooling chamber as the cooling belt conveyor conveys the gum product. As mentioned above, one or more of the above embodiments may be employed alone or in combination to cool the gum.

Additionally, although the majority of the individual cooled strands of gum product are agglomerated by coming into contact with each other when the individual cooled strands collect on the cooling belt conveyor 435, individual cooled strands may also commence the initial stages of agglomeration by coming into contact with each other when the individual strands are moved under the influence of the air blown by the blower 432.

The cooled, agglomerated mass of individual strands of gum product is then passed from the cooling belt conveyor 435 to the forming system 440. At the forming system 440, the gum product is then sized into a desired shape and may be scored if desired. For example, the gum product may be formed to a formed slab of agglomerated strands of gum in a flat plane and then sliced or cut into individual pieces of gum product. Alternatively, the gum may be formed into a formed slab of agglomerated strands of gum in a flat plane and then scored, in which cuts or impressions are made into the formed slab of agglomerated strands of gum that extend mostly, but not all of the way through the formed slab of agglomerated strands of gum in order to form a scored product. The scored product may then be more easily broken into individual pieces by an end user by breaking the scored product along the places where the product has already been scored. Additionally, the formed slab of agglomerated strands of gum may be scored in either one or both of the top and bottom. Any means of scoring, forming, and/or cutting may be employed.

In one embodiment, the gum product is formed into formed slab of agglomerated strands of gum in a flat plane and the flat plane is then scored by contacting both the top and bottom of the formed slab of agglomerated strands of gum with a stamping impression of individual pieces of gum products. The scored formed slab of agglomerated strands of gum is then sliced along a plurality of the scoring lines to separate the formed slab of agglomerated strands of gum into a plurality of pieces of gum product, each piece including further scored portions.

After the formed slab of agglomerated strands of gum is sized and/or scored, the formed slab of agglomerated strands of gum is then passed to the packaging system 450. The packaging system 450 packages the gum product, for example wrapping in paper or foil.

In addition, at any point between the blender 405 and the apertures 420, the gum may be melted and/or cooled to condition the gum and/or induce a desired temperature in all or part of the gum. For example, once the gum passes into the extruder, the gum may first be melted, then slightly cooled, then cooled further, and then warmed prior to passing through the apertures 420. In one embodiment, the extruder may include a first processing area at least partially melting the gum, a second processing area at least partially cooling the gum, and a third processing area at least partially warming the gum prior to introducing the gum through said plurality of apertures.

Further the extrusion die preferably includes a plurality of apertures, but may include as few as one or as many as desired and allowed by the physical setup of the extruder.

Additionally, although FIG. 4 illustrates the apertures arranged horizontally, the apertures may be arranged vertically, in a grid, or in any desired pattern or configuration.

Additionally, although FIG. 4 shows all of the apertures as being the same size, one or more of the apertures may be larger or smaller than the other apertures in order to produce a strand of gum product that is of a slightly different size than another strand of gum that is also being produced.

Additionally, the extrusion die may be vibrated, such as with an ultrasonic system. The vibration may ease the passage of the gum through the apertures. For example, the vibration may reduce the friction between the gum and an equipment surface and/or die edge.

Also, the extrusion die may have a static electricity charge system. The static electricity charge/discharge system may discharge a static charge that may build up on the extrusion die. Alternatively, the static electricity charge/discharge system may induce an electric charge into the individual strands of gum so that the individual strands of gum may be attracted or repelled from each other.

Additionally, the cooling system 430 may include alone or in combination an air knife, a jet air blower, a fan, a table fan, a venturi air blower, and/or a venture ring.

Additionally, the forming system 440 may employ hot/heated or cold stamping or heated or unheated rollers, such as drop rollers, for example.

Additionally, the blender may be a V-blender.

Also, the extruder may include temperature and/or pressure indicators and/or controls.

Also, the size of the apertures in the extrusion die may be about 0.05 mm or about 3.00 mm Alternatively, the size of one or more apertures may be 0.05 mm, 0.5 mm, 1 mm, 1.25 mm, 1.5 mm, 1.75 mm, 2 mm, or 3 mm. In one embodiment, a higher production rate is performed using a larger aperture diameter.

Also, the cooling systems and/or processes mentioned herein may also be embodied as chilling systems and/or processes. One difference being that cooling systems that cool below a certain temperature point or that employ cooling elements that operate below a certain temperature point are sometimes referred to as chilling systems.

Also, in the embodiments employing one or more rollers, the roller may be heated.

Further, the extruder may be any of several types of extruders, such as a screw-type extruder, for example.

The gum itself preferably includes a gum base, and a bulking sweetener agent (sugars and/or polyols). Additionally, the gum may include a softener such as glycerin. Additionally, the gum may include starch, maltodextrin or other materials to adjust the stretch or tenacity of the individual strands of gum when formed.

Additionally, the gum may be sprayed with a liquid ingredient or dusted with a dry ingredient, for example to finish the exterior of the gum. The ingredient may be added during one or more of the blowing process, while the gum is travelling on the conveyor, the sizing/scoring or forming process, and/or the packaging process. Additionally in one embodiment, the gum may be sprayed after agglomeration.

FIG. 5 illustrates an embodiment 500 of the system with a blower and two angled conveyor belts. The embodiment of FIG. 5 includes a blender 505, a feeder 507, a mix apparatus 510, a shape former 515, apertures 520, a cooling system 530 including a blower 532, a bottom cooling belt conveyor 535, and a top cooling belt conveyor 537, a forming system 540, and a packaging system 550.

The embodiment of FIG. 5 is generally similar to the embodiment of FIG. 4, but employs a different cooling system 530. More specifically, in the cooling system 530 of FIG. 5, the individual strands of gum that emerge from the apertures 520 are blown by the blower 532 to arrive between a bottom cooling belt conveyor 535 and a top cooling belt conveyor 537.

More specifically, the blower 532 may be similar to the blower 432 of FIG. 4, but may be configured to emit air at a higher velocity so as to more significantly displace the individual strands of gum. Under the influence of the air emitted from the blower 532, the individual strands of gum may travel several centimeters or meters until the individual strands of gum impact one or both of the bottom cooling belt conveyor 535 or top cooling belt conveyor 537.

Once the individual strands of gum contact one or both of the bottom cooling belt conveyor 535 or top cooling belt conveyor 537, they agglomerate into agglomerated strands of gum. The conveyor belts 535, 537 themselves are positioned so that at their far end they are separated by a distance representing the desired height of a formed slab of agglomerated strands of gum. Thus, once the individual strands of gum contact one or more of the bottom cooling belt conveyor 535 or top cooling belt conveyor 537 and are agglomerated, the agglomerated strands of gum are conveyed by one or more of the bottom cooling belt conveyor 535 and/or top cooling belt conveyor 537. The conveyed strands may then be pressed together to form a formed slab (typically in a flat plane) of agglomerated strands of gum by passing through the gap at the far end of the bottom cooling belt conveyor 535 and top cooling belt conveyor 537.

The formed slab of agglomerated strands of gum is then passed to the forming system 540 and packaging system 550 which operated similar to those system are described above in FIG. 4.

Alternatively, the blower 532 may not significantly horizontally displace the individual strands of gum and the individual strands of gum may proceed substantially vertically downward from the shape former or extrusion die. In this embodiment, the bottom cooling belt 535 is positioned vertically below the extrusion dies to collect the individual strands of gum.

In another embodiment, although the top cooling belt conveyor 537 is shown in FIG. 5 to be orientated at an angle of approximated 45 degrees, the top cooling belt conveyor may be positioned at a lesser angle of substantially 10, 15, 20, or 30 degrees or a greater angle of substantially 50, 60, 70, 80, or even 90 degrees.

For example, on one embodiment, top cooling belt conveyor 537 may be oriented substantially vertically and the velocity and/or volume of air provided by the blower 532 may be such that the individual strands of gum are blown directly into the top cooling belt conveyor or 537. Once the individual strands of gum impact the top cooling belt conveyor 537 and form agglomerated strands, the agglomerated strands may then be induced downward through the action of the top cooling belt conveyor 537.

All of the alternatives described above with regard to the embodiment of FIG. 4 also apply as alternatives to the embodiment of FIG. 5 and the other embodiments described herein.

Additionally, both the top cooling belt conveyor 537 and bottom cooling belt conveyor 535 may cool the gum in one or more of the ways described above with regard to the cooling belt conveyor 435 of FIG. 4. Also, the cooling may be applied by one or both of the top cooling belt conveyor 537 and bottom cooling belt conveyor 535

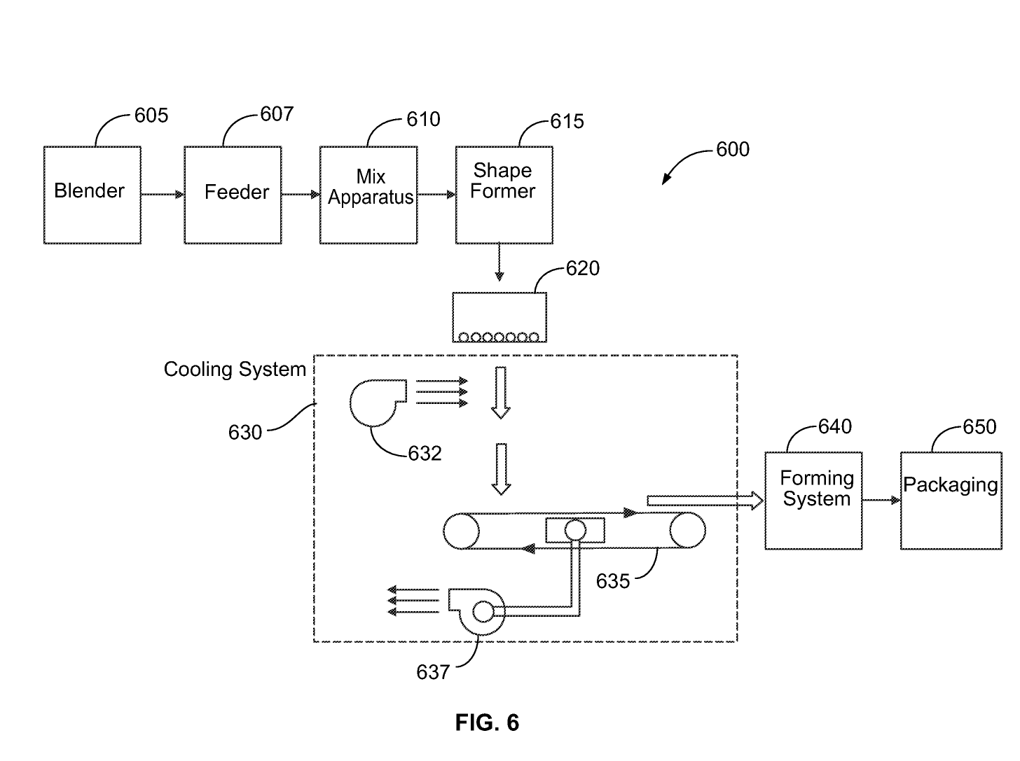

FIG. 6 illustrates an embodiment 600 of the system with a blower and a perforated cooling belt. The embodiment of FIG. 6 includes a blender 605, a feeder 607, a mix apparatus 610, a shape former 615, apertures 620, a cooling system 630 including a blower 632, a suction cooling belt conveyor 635, and a suction blower 637, a forming system 640, and a packaging system 650.

The embodiment of FIG. 6 is generally similar to the embodiments of FIGS. 4 and 5, but employs a different cooling system 630. More specifically, in the cooling system 630 of FIG. 6, the individual strands of gum that emerge from the apertures 620 are blown by the blower 632 and then fall to a suction cooling belt conveyor 635. The suction cooling belt conveyor 635 is perforated with apertures and is connected to the suction blower 637 so as to pull air through the apertures and cool the gum.

In one embodiment, the apertures in the suction cooling belt conveyor 635 are positioned in the outer surface of the cooling belt and, under the influence of the suction provided by the suction blower 637, provide a suction that interacts with the individual strands of gum to draw the individual strands of gum down onto the suction cooling belt conveyor 635. Additionally, the suction may be provided through the suction cooling belt conveyor 635 along only a finite length of the suction cooling belt conveyor 635.

For example, a section of the suction cooling belt conveyor 635 directly below the extrusion die may have positioned underneath it a compartment that is connected to the suction blower. Further, the belt running on the suction cooling belt conveyor 635 may include a plurality of apertures or holes along its length. When one or more holes of the suction cooling belt conveyor 635 pass over the compartment, air may be drawn through the hole in the belt and into the compartment by the influence of the blower. As the belt continues moving on the conveyor and reaches the edge of the compartment, the suction then ceases. However, the individual strands of gum have been positioned on the belt under the influence of the suction. In some instances, the gum may also be cooled by the passage of air due to the suction.

The holes in the belt are preferably small enough, the gum sturdy enough, and the suction light enough so that the gum is not pulled through the holes or engaged with the holes beyond the ability to be easily separated.

Additionally, although a single suction blower is shown in FIG. 6, multiple suction blowers may be employed. Additionally, different compartments and/or a plurality of suction regions may be employed. Also, suction may be employed at different levels in different regions. For example, a higher suction may be provided in regions near the edge of the conveyor to help prevent strands of gum from being blown off of the conveyor.

Additionally, all of the embodiments shown in FIGS. 3-7 may include a slanted or vertical retaining wall at the edges of the conveyor to assist in retaining blown strands of gum. The retaining wall may be coated with a non-stick component and/or may be vibrated to minimize sticking of strands of gum on the retaining wall. Strands of gum impacting the retaining wall are thus directed back onto the conveyor.

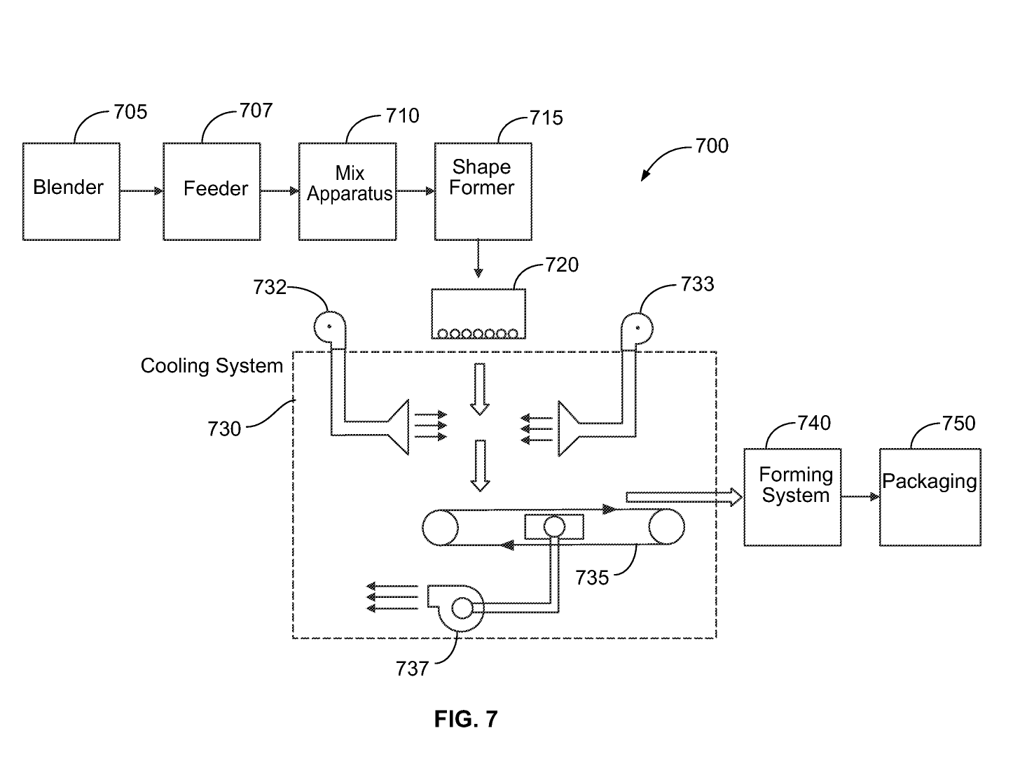

FIG. 7 illustrates an embodiment 700 of the system with a plurality of blowers and a perforated cooling belt. The embodiment of FIG. 7 includes a blender 705, a feeder 707, a mix apparatus 710, a shape former 715, apertures 720, a cooling system 730 including a first blower 732, an opposing blower 733, a suction cooling belt conveyor 735, a suction blower 737, a forming system 740, and a packaging system 750.

The embodiment of FIG. 7 is generally similar to the embodiments of FIGS. 4, 5, and 6, but employs a different cooling system 730. More specifically, in the cooling system 730 of FIG. 7, the individual strands of gum that emerge from the apertures 720 are blown by both the first blower 732 and the opposing blower 733 and then fall to the suction cooling belt conveyor 735. As in FIG. 6, the suction cooling belt conveyor 735 is perforated with apertures and is connected to the suction blower 737 so as to pull air through the apertures and cool the gum.

The operation of the first blower 732 and the opposing blower 733 provides one or more of the following advantages.

First, because the blowers are opposing, the total volume of air flow provided by the blowers in combination to the individual strands of gum may be increased with or without increasing the horizontal displacement of the individual strands of gum. In this regard, the additional air flow may provide additional cooling and/or de-moisturizing of the individual strands of gum without inducing a horizontal displacement that might stretch or provide a force on the gum. Further, in one embodiment, the conveyor belt may be a horizontally vibrating conveyor belt.

Also, the two opposing blowers may cause the individual strands of gum to start agglomerating earlier and/or to a greater extent before they fall to the suction cooling belt conveyor 735.

Additionally, the greater airflow and greater agglomeration produced by the two opposing blowers may provide for more and/or greater volume of air pockets in the agglomerated strands of gum.

Additionally, one or more of the blowers (or any of the blowers described herein) may blow heated air if desired. For example, the ambient air may need to be raised to a certain temperature before being blown on the strands for one or more of a variety of reasons, such as process regulation in light of differing ambient air temperatures, and/or a different desired temperature for the gum product for ease of processing, such as mechanical processing.

Additionally, although two blowers are shown in FIG. 7, a greater number of blowers may be employed. Additionally, the blowers may be arranged in a ring or another structure around or partially around the individual strands of gum.

After the individual strands of the gum product pass between the blowers 732 and 733, the individual strands of gum fall to the suction cooling belt conveyor 735 that operates similarly to the suction cooling belt conveyor 635 of FIG. 6. The gum then passes from the suction cooling belt conveyor 735, to the forming system 740, and the packaging system 750.

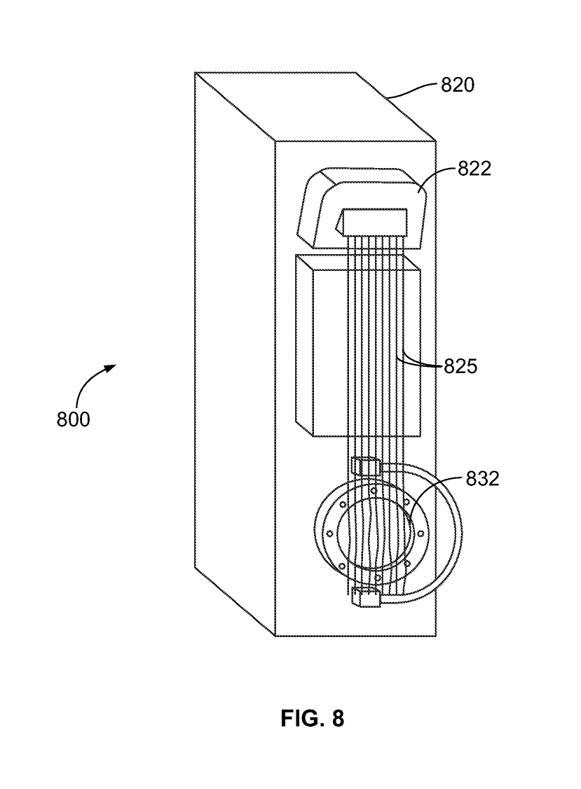

FIG. 8 illustrates one embodiment 800 of the extrusion plate and blower. FIG. 8 includes an extruder 820, an extrusion die 822, individual strands of gum 825, and a blower 832.

As shown in FIG. 8 and described above, the extruder 820 induces the gum product to pass through and/or flow through the apertures in the extrusion die 822 to form several individual strands of gum 825. The individual strands of gum 825 then proceed generally downwardly under the influence of gravity. The blower 832 preferably continuously generates an airflow that comes into contact with the individual strands of gum 825.

In one embodiment, the individual cooled strands of gum may be agglomerated into a slab, mass, bundle, or flat plane of agglomerated strands of gum. That is, the individual strands may be pressed into contact with each other in a chaotic, non-uniform way or in a more uniform pattern in another embodiment. The cooling reduces gum stickiness and flow-ability and assists the gum in maintaining the appearance of a strand during agglomeration and/or forming

In one embodiment, because the individual strands have been cooled by the cooling system, and the agglomeration process exerts a relatively small pressure on the individual strands when forming the agglomerated strands, the individual stands substantially maintain their character as individual strands when formed into the agglomerated strands. For example, instead of the agglomerated strands having the appearance of a solid, uniform article that traditional gum has, the agglomerated strands may have the appearance of many individual strands pressed relatively loosely together. Further, the relatively loose agglomeration of the strands typically allows the formation of many air voids internal to the agglomerated strands. The resultant agglomerated strands thus have less gum mass per piece volume than a traditional chunk of chewing gum of the same volume.

With regard to forming the individual pieces of gum product, in one embodiment the individual pieces may be rectangular or cubic. Additionally, the finished gum product (either individual pieces or formed slab) may be wrapped in paper or foil and/or placed in a carton.

Additionally, agglomeration of the individual strands of gum product may take place by gathering the individual strands of gum in a container. In one embodiment, the blower may be configured to blow the individual strands of gum directly into a container for agglomeration.

Additionally, although the individual strands of gum may have a generally cylindrical shape and thus be generally circular in cross section, different cross sections may be provided by altering the extrusion die. For example, square, rectangular, elliptical, triangular, and/or star-shaped cross sections may be provided. Additionally, individual strands having different cross sections and/or sizes may be combined into a single formed slab of agglomerated strands of gum.

Additionally, as mentioned in the Background above, gum has previously been offered in shredded form. However, the shredded gum is formed by merely shredding a thin roll of gum. Further, the pieces of the shredded gum are not agglomerated and formed into a gum product. Additionally, the diameter of the shredded gum is much thicker than the diameter of a present strand of gum product. Additionally, standard gum undergoing the shredding process may not be stretched like the present strands. The thin strands of gum that may be produced with the system above may allow the resulting gum product to be very low or light density, for example by including air voids, pockets, or open structures in the gum product.

Additionally, in one or more embodiments, the extruder may be any of a pin-type extruder, a screw-type extruder, a rotor and stator extruder, or a pin and fin extruder.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

What is claimed:

1. A method for forming a chewing gum product, said method including:
inducing a gum product through a plurality of apertures in an shape former to form a plurality of individual strands of extruded gum product;
cooling said plurality of individual strands of extruded gum product to form a plurality of individual cooled strands of gum product;
agglomerating said plurality of individual cooled strands of gum product into a mass of individual cooled strands of gum product; and
forming said mass of individual cooled strands of gum product into a shaped gum product having a predetermined shape.

2. The method of claim 1 further including stretching said gum product after it passes through said plurality of apertures.

3. The method of claim 2 wherein said stretching stretches said gum product into thin strands.

4. The method of claim 2 wherein said stretching occurs using airflow.

5. The method of claim 4 wherein said airflow is provided by an air knife.

6. The method of claim 4 wherein said airflow is provided by a jet air blower.

7. The method of claim 4 wherein said airflow is provided by a fan.

8. The method of claim 4 wherein said airflow is provided by a venturi air blower.

9. The method of claim 4 wherein said airflow is provided by a venturi ring.

10. The method of claim 1 wherein said agglomerating said plurality of individual cooled strands of gum product is performed by collecting them in a container.

11. The method of claim 1 wherein said agglomeration of said individual cooled strands of gum product includes collecting them on a conveyor belt.

12. The method of claim 11 wherein said conveyor belt is cooled.

13. The method of claim 11 wherein said conveyor belt employs suction to draw said individual strands of gum product to said belt.

14. The method of claim 1 wherein said agglomerating provides said plurality of individual cooled strands of gum product in an agglomerated mass.

15. The method of claim 1 wherein said forming includes forming said plurality of individual cooled strands of gum product into a predetermined shape using stamping.

16. The method of claim 15 wherein said stamping is heated stamping.

17. The method of claim 1 wherein said forming includes forming said plurality of individual cooled strands of gum product into a predetermined shape using at least one roller.

18. The method of claim 17 wherein said forming uses a plurality of rollers.

19. The method of claim 17 wherein said at least one roller is heated.

20. The method of claim 1 wherein said predetermined shape is a rectangular segment.

21. The method of claim 1 wherein said extrusion die includes an electrostatic charge.

22. The method of claim 1 wherein said extrusion die includes vibration.

23. The method of claim 1 wherein said gum product is induced through said plurality of apertures using an extruder.

24. The method of claim 23 wherein said extruder is a rotor and stator extruder.

25. The method of claim 24 wherein said extruder is a pin-type extruder.

26. The method of claim 24 wherein said extruder is a screw-type extruder.

27. The method of claim 23 wherein said extruder includes a processing area that melts said gum product.

28. The method of claim 23 wherein said extruder includes a processing area that cools said gum product.

29. The method of claim 23 wherein said extruder includes a processing area that warms said gum product.

30. The method of claim 1 further including spraying said shaped gum product with a liquid ingredient.

31. The method of claim 23 wherein said extruder includes a first processing area at least partially melting said gum product, a second processing area at least partially cooling said gum product and a third processing area at least partially warming said gum product prior to introducing said gum product through said plurality of extrusion apertures.

32. An apparatus for forming a chewing gum product, said apparatus including:
an extrusion die having a plurality of extrusion apertures for extruding a gum product;
an extruder introducing said gum product through said plurality of extrusion apertures;
a cooling system cooling said gum product after it passes through said plurality of extrusion apertures to form a plurality of individual cooled strands of gum product; and
a forming system agglomerating and forming said plurality of individual cooled strands of gum product into a predetermined shape.

33. A chewing gum product formed by a method comprising:
inducing a gum product through a plurality of apertures in an extrusion die to form a plurality of individual strands of extruded gum product;
cooling said plurality of individual strands of extruded gum product to form a plurality of individual cooled strands of gum product;
agglomerating said plurality of individual cooled strands of gum product into a mass of individual cooled strands of gum product; and
forming said mass of individual cooled strands of gum product into a shaped gum product having a predetermined shape.
